(19) United States
(12) Patent Application Publication
(10) Pub. No.: US 2018/0253673 A1
(43) Pub. Date: Sep. 6, 2018

(54) REAL-TIME MONITORING OF TERRESTRIAL LOGISTICS NETWORKS

(71) Applicant: Microsoft Technology Licensing, LLC, Redmond, WA (US)

(72) Inventors: David Lee Langer, Bothell, WA (US); Vijeyanandh Palaniappan, Redmond, WA (US); Sebastian K. Anil Philip, Bellevue, WA (US); Namratha Sathish, Santa Margarita, CA (US); Jaideep Gotte, Bellevue, WA (US); Geoffrey Coyner, Seattle, WA (US)

(73) Assignee: Microsoft Technology Licensing, LLC, Redmond, WA (US)

(21) Appl. No.: 15/447,004

(22) Filed: Mar. 1, 2017

(51) Int. Cl. G06Q 10/06

(52) U.S. Cl. CPC G06Q 10/06315; G06Q 10/0635

(57) ABSTRACT

A computing system for monitoring a terrestrial logistics network includes an event monitoring module, a logistics module, and a mapping module. The event monitoring module is configured to extract event classifications and event spatial locations from messages broadcast from a curated plurality of independent third party broadcasting entities. The logistics module is configured to assemble an augmented relational database representing a terrestrial logistics network that includes a plurality of interrelated nodes. The augmented relational database includes a spatial location for each interrelated node. The mapping module is configured to output a computer interface visually summarizing contents of both the augmented relational database and the spatial locations and classifications of events. In this way, events may be viewed in the context of the terrestrial logistics network, allowing for the deployment of proactive solutions to potential network disruptions.

### BACKGROUND

Supply chains may include intricate networks of suppliers, manufacturers, trading partners, warehouses, retailers, etc. Unmanageable events such as severe weather, seismic activity, and political unrest may disrupt the supply chain networks, potentially leading to lost sales and revenue.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computing system for monitoring a terrestrial logistics network includes an event monitoring module, a logistics module, and a mapping module. The event monitoring module is configured to extract event classifications and event spatial locations from messages broadcast from a curated plurality of independent third party broadcasting entities. The logistics module is configured to assemble an augmented relational database representing a terrestrial logistics network that includes a plurality of interrelated nodes. The augmented relational database includes a spatial location for each interrelated node. The mapping module is configured to output a computer interface visually summarizing contents of both the augmented relational database and the spatial locations and classifications of events. In this way, events may be viewed in the context of the terrestrial logistics network, allowing for the deployment of proactive solutions to potential network disruptions.

### BRIEF DESCRIPTION OF THE DRAWINGS

FIG. 1A schematically shows a terrestrial logistics network.

FIG. 1B schematically shows a node that may be included in the terrestrial logistics network of FIG. 1A.

FIG. 2 schematically shows an example computing system that may be used in connection with the systems and methods described herein.

FIG. 3 schematically shows a workflow for extracting unmanageable event classifications and spatial locations from messages broadcast by independent third party broadcasting entities.

FIG. 4 shows a method of assembling an augmented relational database including spatial locations for interrelated nodes of a terrestrial logistics network.

FIG. 5 shows an example mapping interface simultaneously displaying unmanageable events with nodes of a terrestrial logistics network.

FIG. 6 schematically shows an example computing system.

### DETAILED DESCRIPTION

Supply chains for major companies may include intricate networks of suppliers, manufacturers, trading partners, warehouses, retailers, etc. Ensuring that a product can be delivered to a customer requires careful management and monitoring of each facet of the supply chain. For example, the movement of materials and products throughout the supply chain network must be carefully tracked. Each of the different nodes of a supply chain are interrelated and interdependent, be it directly or indirectly. As such, anticipating events and risks that impact each aspect of the supply chain is tantamount to ensuring timely and cost-effective delivery of products to customers.

Some disruptive events may impact the entirety of a supply chain network. For example, a supplier of raw materials or components may reduce their output capacity, thus capping the number of devices that may be manufactured over a given time period. Such an event may require mitigating actions, such as repurposing warehouses, managing customer expectations, adjusting quantities of components that are purchased from other suppliers, etc.

Forward-thinking supply chain management may allow for such disruptive events to be anticipated and for proactive correction plans to be enacted prior to a significant disruption impacting the supply chain. However, unmanageable events such as severe weather, seismic activity, and political unrest may unexpectedly disrupt local portions of a supply chain network. Such unmanageable events may selectively impact timelines, inventory, shipments, and demand at particular nodes of a supply chain based on the location of a node and/or the location of an inter-node vector (e.g., a shipping lane) within the supply chain network.

In order to recognize and mitigate the impact of unmanageable events on a supply chain, geospatial information pertaining to these events may be combined with geospatial information pertaining to potentially impacted supply chain nodes. This may allow for co-analysis and/or co-visualization of the unmanageable event and the supply chain, and thus allow for the determination of a proactive solution. However, obtaining real-time information regarding unmanageable events may require a monitoring service to subscribe to and manually monitor multiple private information services, each of which may require subscription fees. Alternatively, the monitoring service may manually monitor countless public information services, which may provide an overwhelming amount of irrelevant information as well as a significant amount of redundant information.

Once obtained, the location of an unmanageable event, along with other pertinent event information, may be merged with available information regarding supply chain nodes and inter-node vectors. However, performing any useful analysis on such a data set may require that the supply chain database be similarly formatted to the unmanageable event data. Many supply chain databases include descriptive, textual information (e.g., street addresses) for supply chain nodes, rather than numeric, spatial locations (e.g., latitude and longitude coordinates). As such, generating a single, combined database which updates in real-time presents many challenges.

Problems associated with an unmonitored or a manually monitored supply chain or other terrestrial logistics network may be overcome by a computing system configured to automatically monitor the terrestrial logistics network. Unmanageable and/or disruptive events may be monitored by receiving and parsing messages broadcast by independent third party broadcasting entities. The broadcast messages may be mined for content indicating the nature of an unmanageable event and a spatial location of the unmanageable event.

A relational database for the terrestrial logistics network may be augmented by geocoding each node of the network with a spatial location. The augmented database may then be fed to a mapping module, whereby the terrestrial logistics network can be visualized. Unmanageable events may be co-visualized with the terrestrial logistics network via the mapping module, allowing for potential disruptions to the terrestrial logistics network to be visualized, and for proactive solutions to be applied. In this way, the impact of an unmanageable event on a terrestrial logistics network may be mitigated without requiring costly, specialized geographic information systems (GIS).

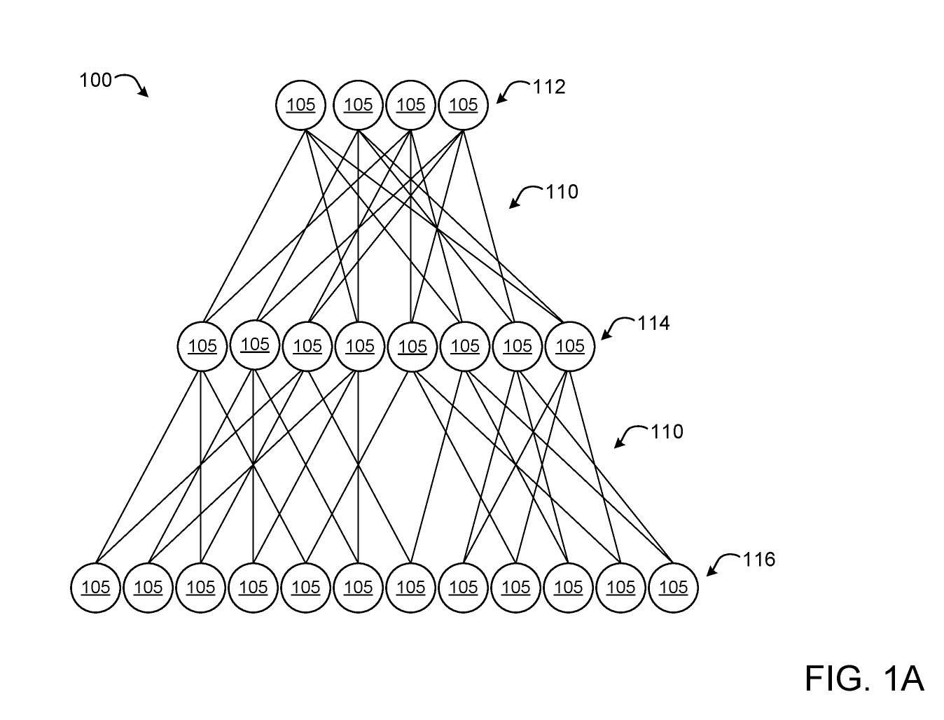

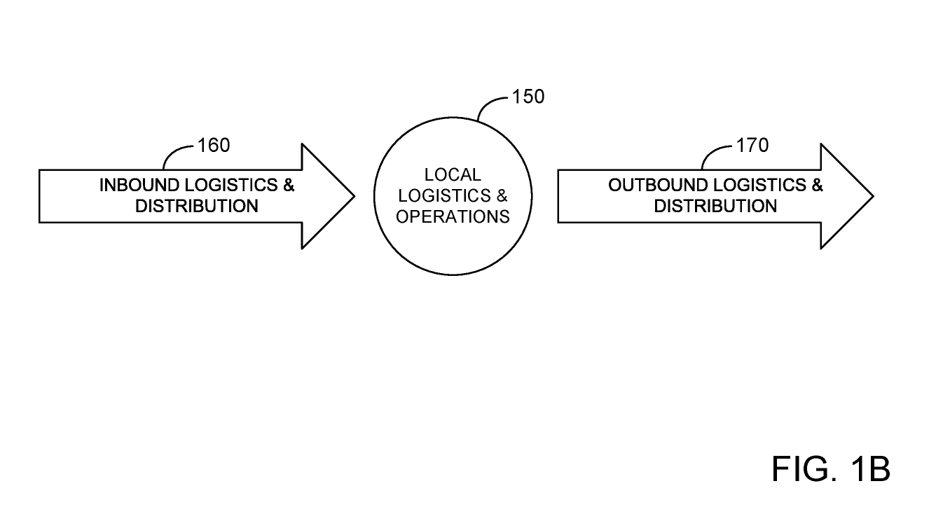

FIG. 1A schematically shows a terrestrial logistics network 100. Terrestrial logistics network 100 includes a plurality of nodes 105, each node representing a physical location at a geospatial location. Nodes 105 are both interdependent and interrelated, either directly or indirectly. Each node 105 may be connected to one or more additional nodes 105 via one or more inter-node vectors 110. In this example, terrestrial logistics network 100 is a multi-tiered network comprising three tiers of nodes (112, 114, 116), however, other networks may include a greater or lesser number of tiers. In this example, a first tier of nodes 112 is connected to a second tier of nodes 114. Second tier of nodes 114 is further connected to a third tier of nodes 116. Inter-node vectors 110 may represent physical means of connecting nodes, such as shipping & transportation routes.

As an example, terrestrial logistics network 100 may be a supply chain network. For example, nodes 112 may represent suppliers of a raw material or component, nodes 114 may represent original equipment manufacturers (OEM), and nodes 116 may represent distribution channels, such as dealers and distributors. Materials and/or components may be shipped from nodes 112 along inter-node vectors 110 to nodes 114. Products may be synthesized/assembled at nodes 114, and then shipped along inter-node vectors 110 to nodes 116. Inter-node vectors 110 may include land shipping channels such as highways and railways, water shipping channels, and air shipping channels.

As another example, terrestrial logistics network 100 may be an emergency response network. For example, nodes 112 may represent suppliers of a vaccine against an infectious disease, nodes 114 may represent regional hospitals, and nodes 116 may represent local clinics. Vaccines may be shipped from nodes 112 along inter-node vectors 110 to nodes 114. Patients may be triaged at nodes 116 and transported to nodes 114 along inter-node vectors 110. Regional hospitals at nodes 114 may thus be tasked with treating arriving patients, procuring providers, containing the disease outbreak, and transporting unaffected patients to outside facilities.

As another example, terrestrial logistics network 100 may be a transportation network. Nodes 112, 114, and 116 may represent destinations, such as cities, in three different geographic regions, while inter-node vectors 110 represent various highways, railways, airways, and waterways that traverse the geographic space between nodes.

Operations at each node of a terrestrial logistics network may thus be dependent on operations at other nodes that are directly connected, as well as on operations at other nodes within the network that are indirectly connected. FIG. 1B schematically shows a node 150 that may be included in terrestrial logistics network 100. Node 150 may be tasked with specific logistics and operations to be performed locally at the node location. Using the example of a supply-chain network wherein node 150 represents an OEM facility, local operations may include storage of raw materials and components, managing inventory of materials and components, assembly of products, quality control of products, packaging of products, maintenance of robotics, management of workers, etc. Node 150 may also be tasked with inbound logistics and operations 160 relating to suppliers of materials and components. For example, materials and components may be sourced, shipments received, and materials and components tested. Node 150 may also be tasked with outbound logistics and operations 170 relating to distributors of assembled products. For example, assembled products may be delivered to warehouses, distributors, dealers, and/or direct to consumers.

Managing logistics at a node is thus dependent on activities at neighboring nodes as well as the viability of adjoining inter-node connectors. Delays or disruptions in receiving raw materials and components may hinder assembly of a product, which in turn may reduce the quantity of products that can be shipped for distribution. Changes in retail strategy may reduce the demand for a product, and thus reduce the demand for components and raw materials from suppliers.

While some impacts on a terrestrial logistics network may be predictable in advance or built-in to a management strategy, other events that locally impact nodes and inter-node connectors may emerge spontaneously and thus require a rapidly enacted proactive correction plan. Such events may be unmanageable and/or disruptive, and may include major weather events, infectious disease outbreaks, seismic activity, traffic, criminal incidents, political situations, etc.

For example, a disruptive event such as a hurricane or earthquake may cut an OEM off from one or more suppliers due to an impact at the supplier or along a shipping route. The OEM may then choose to source materials from a different, unaffected supplier, or the supplier may choose to ship materials along a different route or via a different means of transport. An unexpected heatwave may increase demand at a retail outlet for Bermuda shorts and decrease demand for snow shovels. The retailer may thus choose to source products from a different OEM, adjusting standing orders from multiple nodes.

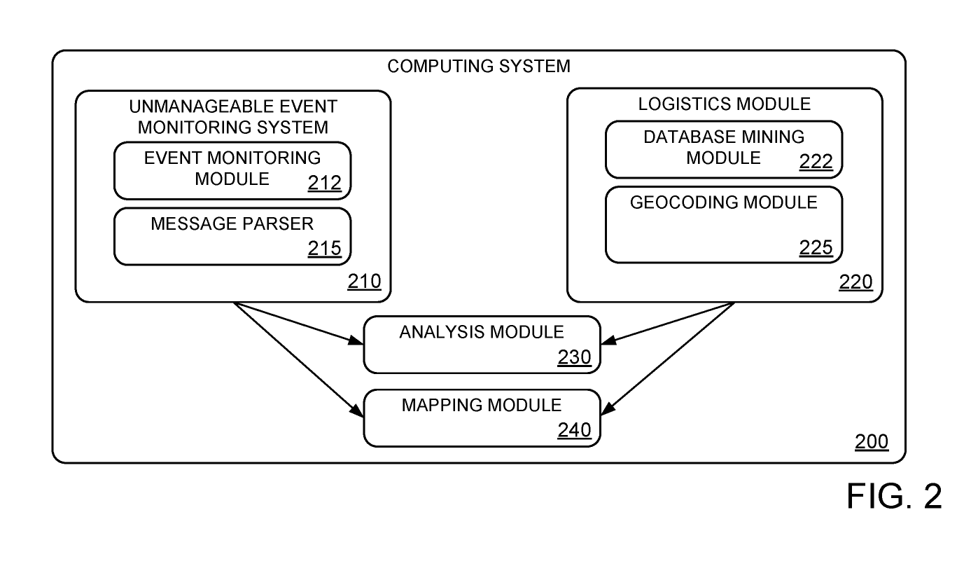

The ability to monitor such unmanageable events and predict the resulting impacts on a terrestrial logistics network is thus critical to proactively adjusting logistics and operations within the network. FIG. 2 schematically shows a non-limiting embodiment of a computing system 200 that may be utilized to monitor a terrestrial logistics network. Computing system 200 includes an unmanageable event monitoring system 210 that may be configured to extract unmanageable event classifications and unmanageable event spatial locations from messages that are broadcast from independent third party broadcasting entities.

Unmanageable event monitoring system 210 includes an event monitoring module 212 and a message parser 215. As one example, event monitoring module 212 may be subscribed to a curated plurality of independent third party broadcasting entities, each of the curated plurality of independent third party broadcasting entities broadcasting event messages using a same broadcasting platform. Event messages received at event monitoring module 212 may then be parsed by message parser 215. Message parser 215 may be configured to automatically parse event messages received from the curated plurality of independent third party broadcasting entities to recognize at least an event classification and an event spatial location.

Computing system 200 further includes a logistics module 220, which includes a database mining module 222 and a geocoding module 225. Logistics module 220 may be configured to assemble an augmented relational database representing a terrestrial logistics network, wherein the terrestrial logistics network includes a plurality of interrelated nodes, and wherein the augmented relational database includes a spatial location for each interrelated node.

As one example, database mining module 222 may be configured to automatically extract descriptive, text-based geospatial information from an initial relational database. In other words, database mining module 222 may automatically extract descriptive node addresses (e.g., street, city, state) from a database representing the terrestrial logistics network. The text-based geospatial information may then be pushed to geocoding module 225, which may be configured to automatically retrieve a spatial location for each interrelated node corresponding to the extracted descriptive node addresses.

Unmanageable event monitoring system 210 and logistics module 220 may be communicatively coupled to one or more of analysis module 230 and mapping module 240. Either or both of analysis module 230 and mapping module 240 may receive an augmented relational database from logistics module 220 and spatial locations and classifications of events from unmanageable event monitoring system 210.

Analysis module 230 may be configured to computer-generate a comprehensive database including the augmented relational database and current unmanageable events, and to automatically discern the impact of each unmanageable event on the plurality of interrelated nodes and/or inter-node vectors. In this way, proactive solutions may be determined and implemented to mitigate such impacts.

Mapping module 240 may be configured to output a computer interface visually summarizing contents of both the augmented relational database and current events, allowing the terrestrial logistics network to be visualized alongside current events. In this way, visual analysis may be performed relating to inter-node transit and shipping, such that more effective inter-node vectors may be selected that are less impacted by the current events.

Computing system 200 may be implemented as a single device and/or as multiple devices. For example, an initial relational database may be stored on a secure server, and thus database mining module 222 may be implemented on the same secure server. Database mining module 222 may thus push data to other computing devices, but data may not be retrieved from the secure server by outside devices. Other components of computing system 200 may be implemented on cloud computing devices, such as analysis module 230 and mapping module 240. In some examples, analysis module 230 and mapping module 240 may be implemented as APIs, and/or as software installed on mobile and/or desktop computing devices.

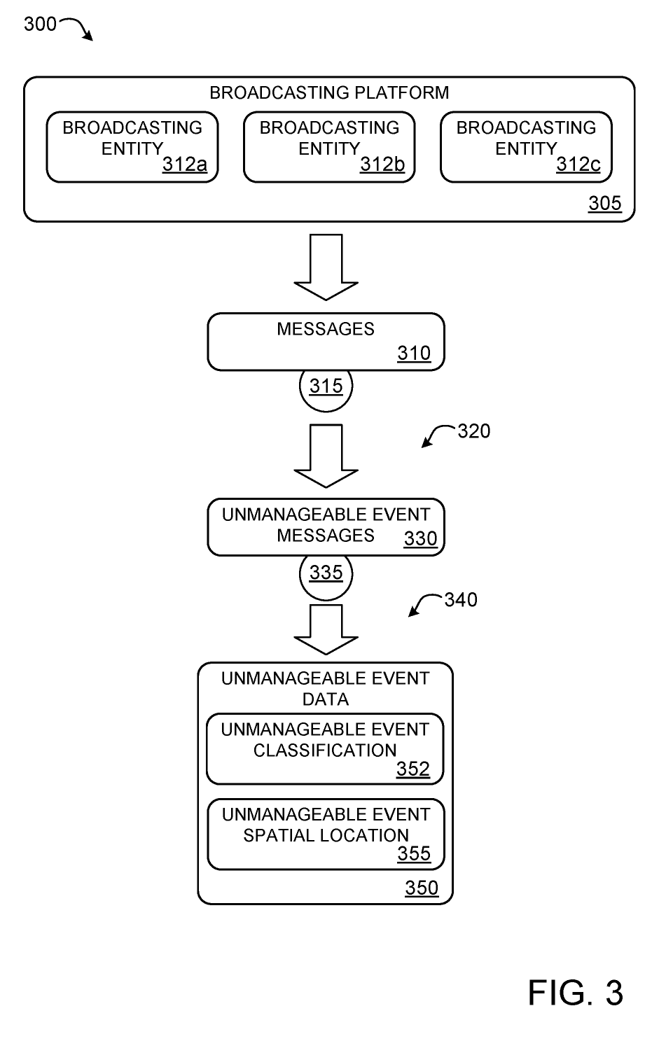

FIG. 3 schematically shows a workflow 300 for extracting unmanageable event classifications and spatial locations from messages broadcast by independent third party broadcasting entities. For example, workflow 300 may be performed by a computing system, such as computing system 200 and/or unmanageable event monitoring system 210. One or more broadcasting platforms 305 may be selected from which to monitor broadcast messages 310. For example, broadcasting platform 305 may include a social networking platform, such as a microblogging platform (e.g., Twitter). In some examples, broadcasting platform 305 may include a short message service, a web syndication service, and/or any other aggregate platform that enables a plurality of independent third party broadcasting entities (312a-312c) to disseminate messages 310 in real-time or near real-time. Broadcasting platform 305 may be selected based on a ratio of potentially relevant data to message length, as well as the ability of independent third party broadcasting entities 312a-312c to incorporate rich geospatial data into messages 310.

An event monitoring module (e.g., event monitoring module 212) may be subscribed to a curated plurality of independent third party broadcasting entities 312a-312c via broadcasting platform 305. Broadcast entities 312a-312c may be curated based on a likelihood of broadcasting messages 310 that are potentially of use for identifying unmanageable events. While three broadcast entities are shown, a smaller or larger number of entities may be subscribed to by the event monitoring module. Broadcast entities 312a-312c may be selected from reliable sources, such as government or quasi-government organizations, and/or from highly verified sources, such as courier delivery services. For example, independent third party broadcasting entities may include, but are not limited to, national and/or local weather services, traffic monitors, transportation departments, geological services, local police, labor & government monitors, centers for disease control, shipping entities, etc.

Broadcast entities need not be contracted, and may be publicly available (e.g., free). Leveraging publically available broadcast entities can decrease costs without sacrificing accuracy because the accuracy and timeliness of messages from such broadcast entities may be consistently very good. The curated plurality of independent third party broadcasting entities may not represent a comprehensive source for all potential unmanageable events, but each third party broadcasting entity may be likely to broadcast usable and verifiable information. Indeed, some third party broadcast entities may be intentionally ignored in order to reduce the frequency of duplicative event mining. The third party broadcasting entities may publically broadcast messages to a generic audience, and may be unaware that their broadcast messages are being mined in this fashion.

Messages 310 may include a text-based message body and one or more metadata elements 315. For example, metadata elements 315 may include a time stamp, a user ID, an IP address, a textual location, a spatial location, etc. Some broadcasting entities may be selected for subscription based on the presence of a spatial location within metadata elements 315. In some examples, the broadcast entity may present a spatial and/or textual location within metadata elements 315 that is indicative of an event location, as opposed to the location of the broadcast entity.

At 320, messages 310 may be computer-evaluated for the presence of information regarding an unmanageable event, for example by an event monitoring module and/or a message parser. For example, messages 310 may be computer-evaluated based on the presence of predetermined keywords, via natural language processing (NLP), named-entity recognition (NER), etc. A subset of messages 310 may then be automatically classified as unmanageable event messages 330 (e.g., disruption messages), and may comprise one or more metadata elements 335.

At 340, unmanageable event messages 330 may be automatically parsed for unmanageable event data 350, for example by a message parser. For example, each unmanageable event messages 330 may be automatically parsed for at least an unmanageable event classification 352 (e.g., disruption classification) and an unmanageable event spatial location 355 (e.g., disruption spatial location). Each unmanageable event classification 352 may correspond to a type of unmanageable event (e.g., earthquake, flood, tsunami, hurricane, traffic event, political situation, criminal incident). The unmanageable event classification 352 may be computer-derived from textual information within the corresponding unmanageable event message 330, though in some examples, the unmanageable event classification 352 may be computer-derived from metadata elements 335.

Each unmanageable event spatial location 355 may correspond to a latitude and longitude of the unmanageable event. The unmanageable event spatial location 355 may be computer-derived from metadata elements 335, though in some examples, the unmanageable event spatial location 355 may be computer-derived from textual information within the corresponding unmanageable event message 330. In some examples, an unmanageable event spatial location 355 may not be included in either unmanageable event message 330 or metadata elements 335. In such a scenario, a textual location, such as a street address, city, and/or state may be computer-extracted from the unmanageable event message 330 or metadata elements 335. A corresponding spatial location may then be automatically derived by geocoding the textual location of the unmanageable event. Additionally or alternatively, a spatial location may be automatically inferred based on an identity of the third party broadcasting entity that issued the unmanageable event message. In some examples, such as for a hurricane, the unmanageable event spatial location 355 may include a plurality of spatial locations covering a geographic region.

In some examples, additional information may be automatically parsed from an unmanageable event message 330 or metadata elements 335. For example, information may be available that indicates the severity of an unmanageable event (e.g., earthquake), the trajectory of an unmanageable event (e.g., storm front), an expected duration of an unmanageable event (e.g., power outage), when additional updates are expected to be available, etc. When available, such information may be included in unmanageable event data 350. Unmanageable event data 350 may be pushed to an analysis module and/or a mapping module. Unmanageable event data 350 may be stored in an unmanageable event database, and/or designated for analysis and/or mapping in real-time following the discernment of a new or updated unmanageable event.

The computing system (e.g., computing system 200) automatically operating or automatically overseeing a terrestrial logistics network may maintain one or more databases including information regarding the location and identity of each node, preferred and alternate inter-node vectors, inbound and outbound logistics and distribution for each node, local logistics and operations for each node, etc. For example, a supply chain network database may include data regarding products, suppliers, orders, lead times, etc. While the information stored in such a database may be comprehensive, the location of nodes and inter-node vectors may be stored as descriptive, textual data that is not readily combinable with the spatial locations extracted for unmanageable events.

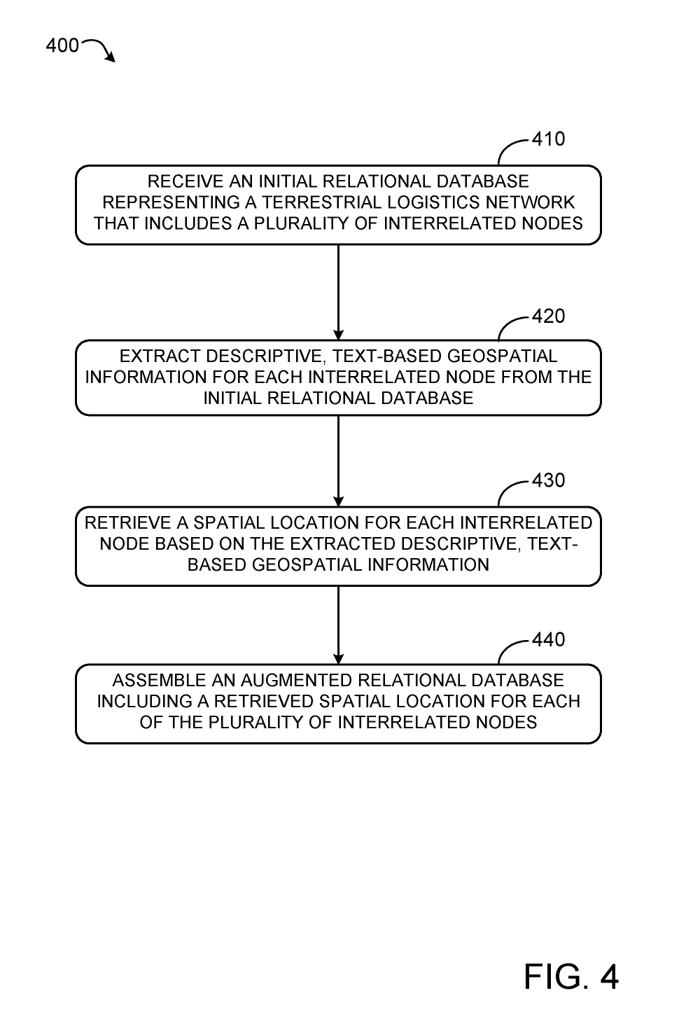

FIG. 4 shows a method 400 for assembling an augmented relational database including spatial locations for interrelated nodes of a terrestrial logistics network. Method 400 may be performed by computing system 200, as one example. At 410, method 400 includes automatically receiving an initial relational database representing a terrestrial logistics network that includes a plurality of interrelated nodes, for example, a supply chain network including a plurality of supply chain nodes. The initial relational database may be a column-based database that includes text-based geospatial information for each node, but may not include spatial locations for each node. The initial relational database may further include data corresponding to inter-node vectors of the terrestrial logistics network.

At 420, method 400 includes computer-extracting descriptive, text-based geospatial information for each interrelated node from the initial relational database, and may further include computer-extracting descriptive, text-based geospatial information for each inter-node vector included in the initial relational database. Computer-extraction may be performed by a database mining module, for example database mining module 222. Descriptive information such as street addresses, cities, states, zip codes, etc. may be automatically retrieved from the initial relational database using machine learning based on the presence of predetermined keywords, via NLP, NER, etc.

At 430, method 400 includes automatically retrieving a spatial location for each interrelated node based on the extracted descriptive, text-based geospatial information, and may further include automatically retrieving a spatial location for each inter-node vector based on the extracted descriptive, text-based geospatial information. For example, a geocoding module, such as geocoding module 225, may automatically retrieve a latitude coordinate and a longitude coordinate corresponding to the extracted street address for a node. In some examples, automatically retrieving a spatial location may additionally include automatically retrieving an altitude. In some examples, incomplete descriptive information may be computer-augmented by additional descriptive information, such as adding a ZIP+4 code to an address for a node.

At 440, method 400 includes computer-assembling an augmented relational database including a retrieved spatial location for each of the plurality of interrelated nodes; the augmented relational database may further include the retrieved spatial location for each inter-node vector. In some examples, the augmented relational database may include the entirety of the initial relational database along with the retrieved spatial location for each node. Alternatively, the augmented relational database may include only a portion of the initial relational database.

As described with regard to FIG. 2, the augmented relational database and current unmanageable events may be pushed to one or more of an analysis module and a mapping module. The analysis module and/or mapping module may receive unmanageable event classifications and unmanageable event spatial locations from the unmanageable event monitoring module and may integrate the unmanageable event classifications and unmanageable event spatial locations with the augmented relational database.

As new and updated unmanageable events are automatically parsed, they may be pushed to the analysis module and/or mapping module, thus providing a real-time, updating unmanageable event database that may be presented visually via the mapping module and/or analyzed via the analysis module. By overlaying the unmanageable events and terrestrial logistics network in a single database, the impact of the unmanageable events may be proactively mitigated.

The analysis module may be configured to automatically adjust and/or automatically suggest adjustments to the terrestrial logistics network based on the locations of the unmanageable events and the nodes and inter-node vectors of the terrestrial logistics network. For example, the analysis module may automatically indicate one or more interrelated nodes and/or inter-node vectors affected by each unmanageable event based on the unmanageable event spatial locations and the spatial locations for each of the plurality of interrelated nodes. The analysis module may automatically indicate alternate inter-node vectors that are unaffected by unmanageable events based on at least the unmanageable event spatial locations.

In the example of a supply chain, adjustments may include, but are not limited to: delivery timelines (both actual and estimated), inbound, outbound, and local logistics, storage and warehousing capacities, materials and inventories, production capacity, supply chain demands, consumer demands, etc. As data is accumulated, the analysis module may automatically discern patterns in unmanageable events, such as locations that are prone to certain types of weather events at certain times of year, and may thus be able to automatically predict future unmanageable events and/or automatically adjust operations and logistics in advance.

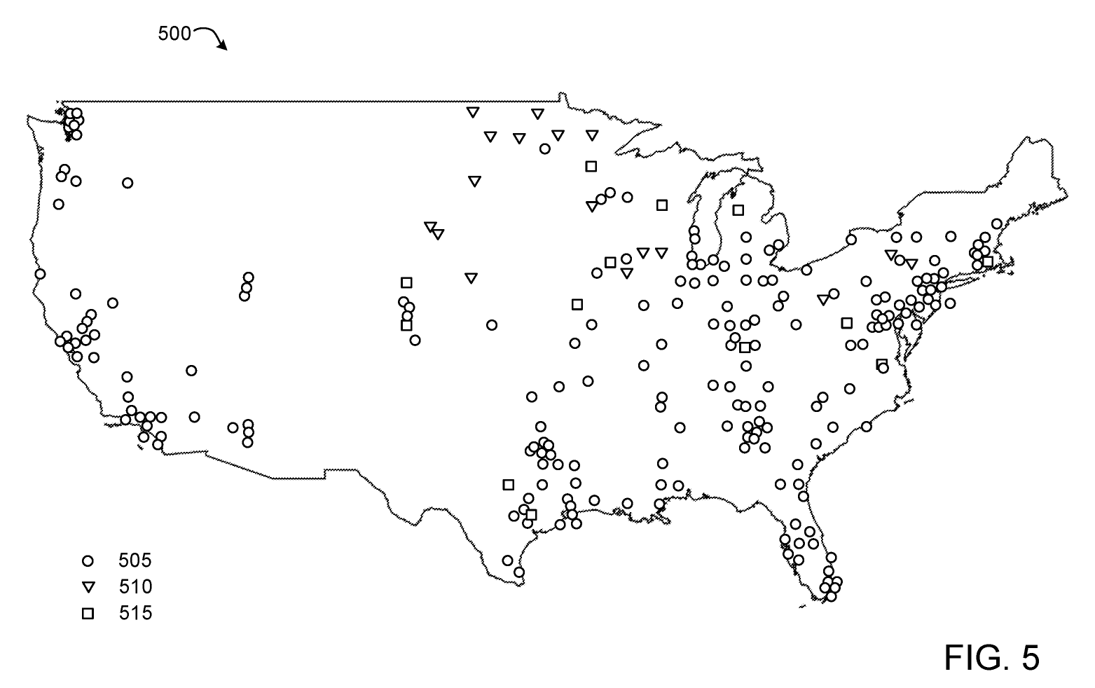

Co-visualizing unmanageable events and the nodes and inter-node vectors of the terrestrial logistics network via a mapping interface may allow for visual analysis regarding the impact of unmanageable events on inter-node transit and shipping. FIG. 5 shows an example mapping interface 500, where nodes 505 (squares), a first class of unmanageable events 510 (circles), and a second class of unmanageable events 515 (triangles) are displayed on a single map of the continental United States. Unmanageable events may be displayed for a predetermined duration, for example, a duration based on the unmanageable event classification. In some examples, unmanageable events may be displayed for a duration based on data included in one or more unmanageable event messages received from an independent third party broadcast entity.

Co-visualizing unmanageable events and a terrestrial logistics network in this way may allow for computer analysis of the impact of unmanageable events on shipments between nodes, and further allow for the development of proactive correction plans. For example, shipping routes or methods may be automatically adjusted to avoid an unmanageable event, and/or a different source may be automatically selected so that an affected inter-node vector is avoided. Both suppliers and retailers may adjust local logistics if an impact to a portion of a supply chain is anticipated.

In some embodiments, the methods and processes described herein may be tied to a computing system of one or more computing devices. In particular, such methods and processes may be implemented as a computer-application program or service, an application-programming interface (API), a library, and/or other computer-program product.

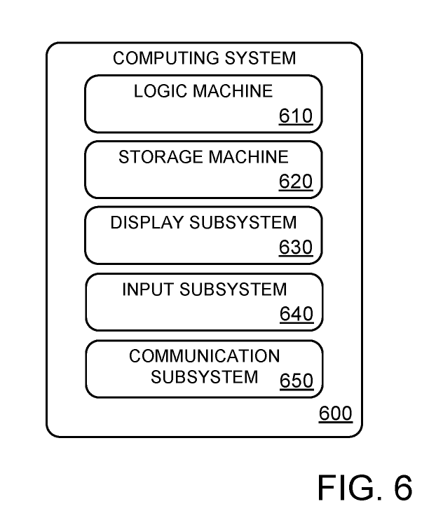

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices. Computing system 600 includes a logic machine 610 and a storage machine 620. Computing system 600 may optionally include a display subsystem 630, input subsystem 640, communication subsystem 650, and/or other components not shown in FIG. 6.

Logic machine 610 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 620 includes one or more physical devices configured to hold instructions executable by the logic machine to implement the methods and processes described herein. When such methods and processes are implemented, the state of storage machine 620 may be transformed—e.g., to hold different data.

Storage machine 620 may include removable and/or built-in devices. Storage machine 620 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 620 may include volatile, nonvolatile, dynamic, static, read/write, read-only, random-access, sequential-access, location-addressable, file-addressable, and/or content-addressable devices.

It will be appreciated that storage machine 620 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 610 and storage machine 620 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 610 executing instructions held by storage machine 620. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 630 may be used to present a visual representation of data held by storage machine 620. This visual representation may take the form of a graphical user interface (GUI). As the herein described methods and processes change the data held by the storage machine, and thus transform the state of the storage machine, the state of display subsystem 630 may likewise be transformed to visually represent changes in the underlying data. Display subsystem 630 may include one or more display devices utilizing virtually any type of technology. Such display devices may be combined with logic machine 610 and/or storage machine 620 in a shared enclosure, or such display devices may be peripheral display devices.

When included, input subsystem 640 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 650 may be configured to communicatively couple computing system 600 with one or more other computing devices. Communication subsystem 650 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

In one example, a computing system for automatically monitoring a terrestrial logistics network comprises an event monitoring module subscribed to a curated plurality of independent third party broadcasting entities, each of the curated plurality of independent third party broadcasting entities broadcasting event messages using a same broadcasting platform; a message parser configured to automatically parse event messages received from the curated plurality of independent third party broadcasting entities to recognize at least an event classification and an event spatial location; a logistics module configured to assemble an augmented relational database representing a terrestrial logistics network, the terrestrial logistics network including a plurality of interrelated nodes, the augmented relational database including a spatial location for each interrelated node; and a mapping module to output a computer interface visually summarizing contents of both the augmented relational database and the spatial locations and classifications of events. In this example, or any other example, each event message includes a text-based message body and one or more metadata elements. In this example, or any other example, recognizing an event spatial location includes recognizing an event spatial location in the text-based message body of an event message. In this example, or any other example, recognizing an event spatial location includes recognizing an event spatial location based on the one or more metadata elements of an event message. In this example, or any other example, recognizing an event spatial location includes inferring an event spatial location based on a third party broadcasting entity broadcasting an event message. In this example, or any other example, recognizing an event classification includes recognizing one or more keywords in the text-based message body of an event message. In this example, or any other example, the event monitoring module is further configured to: receive messages from the curated plurality of independent third party broadcasting entities; evaluate contents of the received messages for a presence of one or more keywords; and classify received messages as event messages based on the presence of the one or more keywords.

In another example, a method for monitoring a terrestrial logistics network comprises parsing event classifications and event spatial locations from messages broadcast from a curated plurality of independent third party broadcasting entities; receiving an initial relational database representing a terrestrial logistics network that includes a plurality of interrelated nodes; extracting descriptive, text-based geospatial information for each interrelated node included in the initial relational database; retrieving a spatial location for each interrelated node based on the extracted descriptive, text-based geospatial information; and assembling an augmented relational database including a retrieved spatial location for each of the plurality of interrelated nodes, and transferring the augmented relational database to an analysis module. In this example, or any other example, the method further comprises: at the analysis module, receiving event classifications and event spatial locations; and integrating the event classifications and event spatial locations with the augmented relational database. In this example, or any other example, the method further comprises: indicating one or more interrelated nodes affected by each event based on the event spatial locations and the spatial locations for each of the plurality of interrelated nodes. In this example, or any other example, the initial relational database further includes data corresponding to inter-node vectors of the terrestrial logistics network. In this example, or any other example, the method further comprises extracting descriptive, text-based geospatial information for each inter-node vector included in the initial relational database; retrieving a spatial location for each inter-node vector based on the extracted descriptive, text-based geospatial information; and including the retrieved spatial location for each inter-node vector in the augmented relational database. In this example, or any other example, the method further comprises indicating one or more inter-node vectors affected by each event based on the event spatial locations and the spatial locations for each of the inter-node vectors. In this example, or any other example, the method further comprises at the analysis module, indicating alternate inter-node vectors that are unaffected by events based on at least the event spatial locations.

In yet another example, a computing system for monitoring a supply chain network comprises an event monitoring module subscribed to a curated plurality of independent third party broadcasting entities, each of the curated plurality of independent third party broadcasting entities broadcasting disruption messages using a same broadcasting platform; a message parser configured to automatically parse disruption messages received from the curated plurality of independent third party broadcasting entities to recognize at least a disruption classification and a disruption spatial location; a database mining module configured to: receive an initial relational database representing the supply chain network that includes a plurality of interrelated supply chain nodes; and extract descriptive, text-based geospatial information for each interrelated supply chain node included in the initial relational database; a geocoding module configured to retrieve a spatial location for each interrelated supply chain node based on the extracted descriptive, text-based geospatial information; a logistics module configured to assemble an augmented relational database including a retrieved spatial location for each of the plurality of interrelated supply chain nodes; and a mapping interface to visually summarize contents of both the augmented relational database and the spatial locations and classifications of disruptions. In this example, or any other example, each disruption message includes a text-based message body and one or more metadata elements. In this example, or any other example, recognizing a disruption spatial location includes recognizing a disruption spatial location in the text-based message body of a disruption message. In this example, or any other example, recognizing a disruption spatial location includes recognizing a disruption spatial location based on the one or more metadata elements of a disruption message. In this example, or any other example, the event monitoring module is further configured to: receive messages from the curated plurality of independent third party broadcasting entities; evaluate contents of the received messages for a presence of one or more keywords; and classify received messages as disruption messages based on the presence of the one or more keywords. In this example, or any other example, the computing system further comprises an analysis module configured to indicate one or more interrelated supply chain nodes affected by each disruption based on the disruption spatial location and the spatial locations for each of the plurality of interrelated supply chain nodes.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for automatically monitoring a terrestrial logistics network, the computing system comprising:
an event monitoring module subscribed to a curated plurality of independent third party broadcasting entities, each of the curated plurality of independent third party broadcasting entities broadcasting event messages using a same broadcasting platform;
a message parser configured to automatically parse event messages received from the curated plurality of independent third party broadcasting entities to recognize at least an event classification and an event spatial location;
a logistics module configured to assemble an augmented relational database representing a terrestrial logistics network, the terrestrial logistics network including a plurality of interrelated nodes, the augmented relational database including a spatial location for each interrelated node; and
a mapping module to output a computer interface visually summarizing contents of both the augmented relational database and the spatial locations and classifications of events.

2. The computing system of claim 1, wherein each event message includes a text-based message body and one or more metadata elements.

3. The computing system of claim 2, wherein recognizing an event spatial location includes recognizing an event spatial location in the text-based message body of an event message.

4. The computing system of claim 2, wherein recognizing an event spatial location includes recognizing an event spatial location based on the one or more metadata elements of an event message.

5. The computing system of claim 2, wherein recognizing an event spatial location includes inferring an event spatial location based on a third party broadcasting entity broadcasting an event message.

6. The computing system of claim 2, wherein recognizing an event classification includes recognizing one or more keywords in the text-based message body of an event message.

7. The computing system of claim 1, wherein the event monitoring module is further configured to:
receive messages from the curated plurality of independent third party broadcasting entities;
evaluate contents of the received messages for a presence of one or more keywords; and
classify received messages as event messages based on the presence of the one or more keywords.

8. A method for monitoring a terrestrial logistics network, comprising:
parsing event classifications and event spatial locations from messages broadcast from a curated plurality of independent third party broadcasting entities;
receiving an initial relational database representing a terrestrial logistics network that includes a plurality of interrelated nodes;
extracting descriptive, text-based geospatial information for each interrelated node included in the initial relational database;
retrieving a spatial location for each interrelated node based on the extracted descriptive, text-based geospatial information; and
assembling an augmented relational database including a retrieved spatial location for each of the plurality of interrelated nodes, and transferring the augmented relational database to an analysis module.

9. The method of claim 8, further comprising:
at the analysis module, receiving event classifications and event spatial locations; and
integrating the event classifications and event spatial locations with the augmented relational database.

10. The method of claim 9, further comprising:
indicating one or more interrelated nodes affected by each event based on the event spatial locations and the spatial locations for each of the plurality of interrelated nodes.

11. The method of claim 9, wherein the initial relational database further includes data corresponding to inter-node vectors of the terrestrial logistics network.

12. The method of claim 11, further comprising:
extracting descriptive, text-based geospatial information for each inter-node vector included in the initial relational database;
retrieving a spatial location for each inter-node vector based on the extracted descriptive, text-based geospatial information; and
including the retrieved spatial location for each inter-node vector in the augmented relational database.

13. The method of claim 12, further comprising:
indicating one or more inter-node vectors affected by each event based on the event spatial locations and the spatial locations for each of the inter-node vectors.

14. The method of claim 13, further comprising:
at the analysis module, indicating alternate inter-node vectors that are unaffected by events based on at least the event spatial locations.

15. A computing system for monitoring a supply chain network, the computing system comprising:
an event monitoring module subscribed to a curated plurality of independent third party broadcasting entities, each of the curated plurality of independent third party broadcasting entities broadcasting disruption messages using a same broadcasting platform;
a message parser configured to automatically parse disruption messages received from the curated plurality of independent third party broadcasting entities to recognize at least a disruption classification and a disruption spatial location;
a database mining module configured to:
receive an initial relational database representing the supply chain network that includes a plurality of interrelated supply chain nodes; and
extract descriptive, text-based geospatial information for each interrelated supply chain node included in the initial relational database;
a geocoding module configured to retrieve a spatial location for each interrelated supply chain node based on the extracted descriptive, text-based geospatial information;
a logistics module configured to assemble an augmented relational database including a retrieved spatial location for each of the plurality of interrelated supply chain nodes; and
a mapping interface to visually summarize contents of both the augmented relational database and the spatial locations and classifications of disruptions.

16. The computing system of claim 15, wherein each disruption message includes a text-based message body and one or more metadata elements.

17. The computing system of claim 16, wherein recognizing a disruption spatial location includes recognizing a disruption spatial location in the text-based message body of a disruption message.

18. The computing system of claim 16, wherein recognizing a disruption spatial location includes recognizing a disruption spatial location based on the one or more metadata elements of a disruption message.

19. The computing system of claim 15, wherein the event monitoring module is further configured to:
receive messages from the curated plurality of independent third party broadcasting entities;
evaluate contents of the received messages for a presence of one or more keywords; and
classify received messages as disruption messages based on the presence of the one or more keywords.

20. The computing system of claim 15, further comprising an analysis module configured to indicate one or more interrelated supply chain nodes affected by each disruption based on the disruption spatial location and the spatial locations for each of the plurality of interrelated supply chain nodes.
